(19) United States
(12) Patent Application Publication
(10) Pub. No.: US 2014/0195634 A1
(43) Pub. Date: Jul. 10, 2014

(54) System and Method for Multiservice Input/Output

(71) Applicant: Broadcom Corporation, Irvine, CA (US)

(72) Inventors: Karagada Ramarao KISHORE, Saratoga, CA (US); Ariel HENDEL, Cupertino, CA (US)

(21) Appl. No.: 13/931,417

(22) Filed: Jun. 28, 2013

Related U.S. Application Data
(60) Provisional application No. 61/751,135, filed on Jan. 10, 2013.

(51) Int. Cl. H04L 29/08

(52) U.S. Cl. CPC H04L 67/1097
USPC 709/213

(57) ABSTRACT

An apparatus for multiservice input/output switching includes a plurality of logical storage endpoints coupled to a plurality of remote servers via native input/output bus, a plurality of downstream ports coupled to a plurality of persistent storage drives, a storage transaction switch, and at least one processor configured to communicate with the plurality of remote servers and the plurality of persistent storage drives. The storage transaction switch translates received storage transaction using configured mappings from the server view to the physical view of persistent storage drives. Optionally, a network switch is integrated in the apparatus. Additionally, corresponding methods and computer readable medium embodiments are disclosed.

### CROSS REFERENCE TO RELATED APPLICATIONS

This applications claims the benefit of U.S. Provisional Appl. No. 61/751,135, filed on Jan. 10, 2013, which is hereby incorporated by reference in its entirety.

### BACKGROUND

1. Technical Field

Embodiments relate to shared access to storage media and, in particular, to flexible shared access to a pool of storage media by host servers over a native input/output interface.

2. Background Art

Capacity, performance and power requirements associated with digital data storage devices continue to challenge computing systems such as data processing systems and communications systems. Hard disk drives (HDD), such as, magnetic disks and optical disks, provide relatively inexpensive storage, but are generally considered slow. Volatile memories, such as, dynamic random access memory (DRAM) provide systems with high speed storage, but are expensive and cannot be used when data persistence is desired. Non-volatile memories (NVM), such as, solid state disks (SSD, e.g. flash disk drives) provide a high performance cost-efficient alternative or addition to HDD-based or volatile memory-based memory systems.

The input/output bus communicatively coupling the central processor unit (CPU) of a computing system with the system memory and directly attached storage devices is known as the native IO bus. NVM attached to a computing system's native bus, such as a PCI Express (PCIe) bus, provide for minimal latency and high bandwidth persistent memory. Thus, PCIe SSDs are becoming increasingly popular.

However, in many environments, such as, for example, data center systems with multiple hosts (e.g., server clusters, micro servers, virtualized servers, server racks), the benefits of NVM devices are not realized due to limitations in conventional technology. FIG. 1 illustrates an example conventional rack-based processing system 100 used in many data center or similar applications. Conventional rack-based processing system 100 includes a plurality of servers 102, a storage system 104, and a network switch 106 arranged in a rack. Servers 102 can be any type of computing server. Storage system 104 includes one or more storage devices (not shown) which are directly attached to respective one or more of the servers 102 through connection devices such as Fibre Channel (or other storage) cables 108. The storage media can be HDD, FLASH disk, or other non-volatile storage medium. The storage media are connected to the rest of the system by Fibre Channel interfaces, for example. The data being written to or read from the storage media is transported over Fibre Channel cables after conversion in order to travel between servers 102 and storage system 104. The network switch 106 provides for servers 102 to connect to each other, and to external networks. Each server is connected to the network switch via its own network cable 110. As shown, the network cables are separate and distinct from the storage cables.

Conventional systems such as, for example, the system 100 discussed above, may have inefficiencies due to the manner data is transported between the respective servers and storage media, and also due to the physical connections made between the servers and the storage system and the network switch. Thus, systems and methods are desired for more efficient and flexible sharing of persistent storage drives between servers.

### BRIEF DESCRIPTION OF THE DRAWINGS/FIGURES

Reference will be made to the embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments.

FIG. 1 illustrates a block diagram of a shared storage and server rack, in accordance with an embodiment.

FIG. 2 illustrates a block diagram of a shared storage and networking system for a server rack, in accordance with an embodiment.

FIG. 3A illustrates a multiservice IO switch coupled to a pool of storage media, and a separate network interface and switch in accordance with an embodiment.

FIG. 3B illustrates a storage message format, according to an embodiment.

FIG. 3C illustrates a mapping table, in accordance with an embodiment.

FIG. 4 is a flowchart of a method for sharing storage media among a plurality of servers, in accordance with an embodiment.

FIG. 5 is a flowchart of a method for configuring a multiservice IO switch, in accordance with an embodiment.

FIG. 6 is a flowchart of a method for performing a storage transaction, in accordance with an embodiment.

### DETAILED DESCRIPTION OF THE DISCLOSURE

While the present disclosure is described herein with reference to illustrative embodiments for particular applications, it should be understood that the disclosure is not limited thereto. Those skilled in the art with access to the teachings herein will recognize additional modifications, applications, and embodiments within the scope thereof and additional fields in which the disclosure would be of significant utility.

Embodiments are generally directed to sharing storage media among a plurality of servers. Some embodiments provide a multiservice IO switch that enables a plurality of servers to flexibly share a plurality of SSDs, such as FLASH memory storage, over the native IO interfaces of the servers. Storage space on the plurality of SSDs is shared, in some embodiments, using namespaces that may be defined for respective servers, such as the namespaces in accordance with the NVMe standard, discussed below. The capability to access SSD storage over native IO interfaces provide the servers with access to large non-volatile storage at minimal access latencies and at high throughput. The latencies and throughput experienced in these embodiments may be similar to those provided by similar types of non-volatile memories used as directly-attached storage (DASD). The capability to share the SSD storage enables power-, cost- and space-efficient processing system designs, such as, for example, server racks with external storage arrays for data center applications. The sharing capabilities provided in these embodiments may be similar to some network-attached storage (NAS) or storage area network (SAN) based storage. In yet other embodiments, a network switch is integrated with the multiservice IO switch, thereby achieving further savings and efficiencies in computing systems.

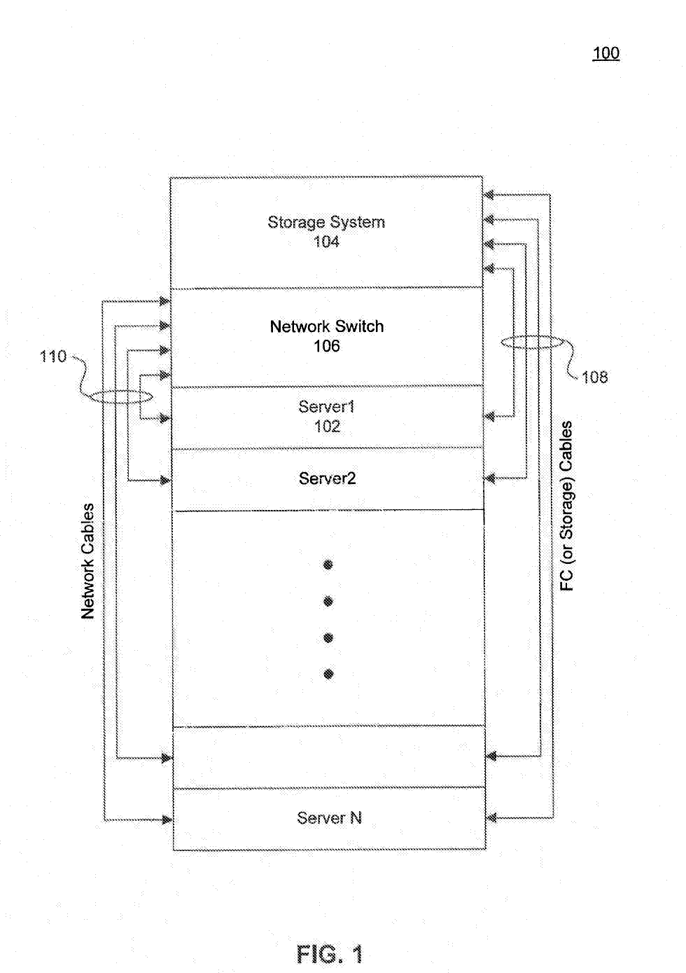

The conventional rack-based processing system 100 shown in FIG. 1 may have several inefficiencies. The servers are coupled to respective storage devices over some interconnection such as Fibre Channel. This requires that the data from the servers are first converted from the native IO format to the Fibre Channel format before being transported to be stored. The conversion adds to cost, latency, and power consumption. Each server communicates with a storage medium via a separate Fibre Channel connection, which may lead to having a relatively large number of physical wires occupying space in the rack structure. Moreover, each server being connected to a particular one or more storage media may limit configuration flexibility and may limit the utilization of the storage media. For example, the capacity of all the separate storage media in storage 104 may not be optimally utilized when storage cannot be dynamically assigned to the servers with the highest data output requirements. Additionally, conventional rack-based processing system 100 includes a network switch 106 to which each server 102 is separately connected, causing even more cables to be accommodated in the rack structure.

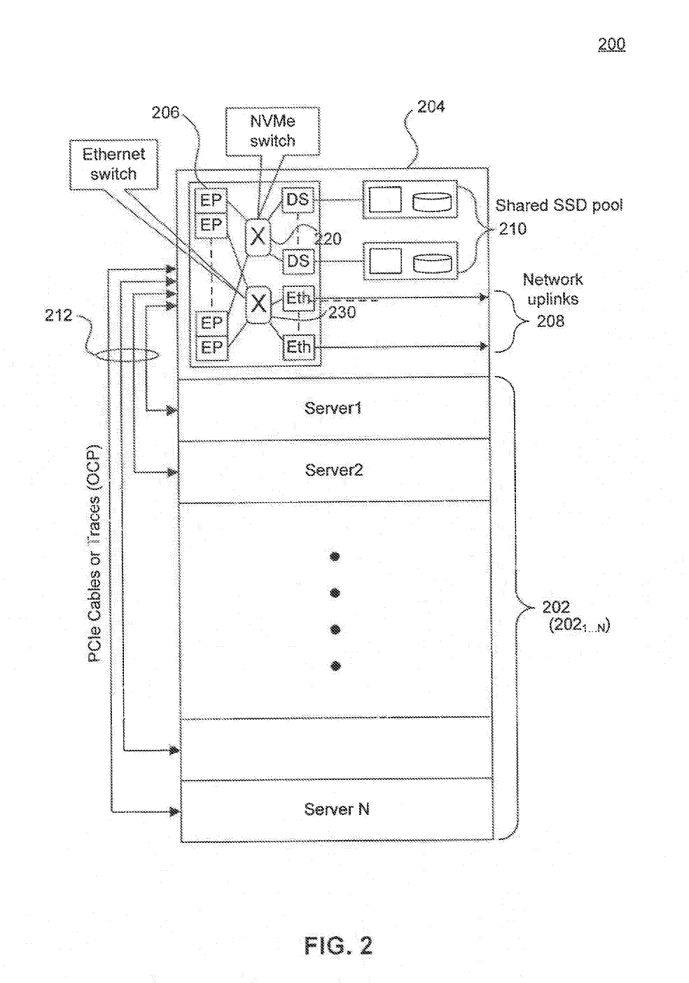

Embodiments disclosed herein include many improvements over the conventional system 100. FIG. 2 illustrates a block diagram of a rack-based processing system 200, in accordance with an embodiment. System 200 includes servers 202₁, 202₂, . . . , 202_{N} (collectively 202), a shared storage pool 210, a multiservice IO switch 206, PCIe cables or traces 212, and network uplinks 208.

Processing system 200 may be used, for example, in a data center, server farm or any other environment where multiple servers are deployed with access to storage resources. In one embodiment, processing system 100 includes a blade enclosure (not shown) in which each server 202, multiservice IO switch 206, and persistent storage drives (or some combinations thereof) are inserted as blades. The blade enclosure may include a backplane which provides the interconnectivity, power, cooling and other services for the individual blades. For example, the PCIe cables (e.g., copper or optical) or traces 212 connecting servers 202 to multiservice IO switch 206 may be integrated on the backplane enclosure and coupled to the native IO interface of each of the blades. It should be noted that in the embodiment shown, the blade enclosure backplane which provides interconnection to the blades may provide for both network and storage interconnectivity within the blade enclosure via the same PCIe cables or traces 212, instead of having separate network and storage cabling (as in conventional system 100).

Although the embodiment in FIG. 2 is illustrated as a rack-based processing system, persons skilled in the art would appreciate that other embodiments may not be rack-based. Other embodiments may include systems where one or more servers connect through a multiservice IO switch such as multiservice IO switch 206 to a plurality of shared persistent storage drives 210.

Each of the servers 202 may be a computer system including at least one central processing unit (CPU) and optionally one or more other processors (e.g., graphics processing units (GPU) or other specialized accelerators). Each server 202 may include its own volatile memory, such as dynamic random access memory (DRAM). In some embodiments, one or more of the servers 202 may also locally include persistent storage. Components within the server, such as the CPU and any other processors, are coupled to a native IO bus. The native IO bus is used to move data from or to the processors and to memory within each server. The embodiments discussed herein are not limited to any particular number of servers 202.

Shared storage pool 210 may include one or more persistent storage devices. The persistent storage drives may be used for read and write access by any, or any combination, of servers 102. Servers 102 may use persistent storage drives 210 for access to stored applications, programs, and data, and, in some embodiments, also for virtual memory. The embodiments discussed herein are not limited to any particular number of persistent storage drives. The persistent storage drives in shared storage pool 210 may include any type of storage, such as, magnetic disk, optical disk, FLASH, or other type of storage in which digital data can be stored for read and write access. In some embodiments, an SSD such as FLASH is used as the storage media in the persistent storage drives. FLASH offers substantially faster access (e.g., lower access latencies), higher storage densities, and lower power consumption than many alternative storage media such as HDD. Due at least in part to the relatively recent cost-efficiencies associated with the technology, FLASH can be now used for even relatively large storage needs, such as storage requirements of data centers and the like.

The use of FLASH or other SSDs with similarly fast access times for storage in embodiments is particularly advantageous. The low access latency associated with FLASH yields a storage medium that is substantially faster than most other large capacity persistent storage devices.

The PCIe interface 212 which is used to couple servers 202 to multiservice IO switch 206 enables the servers to communicate with the persistent storage drives with minimal latency because the intermediate step of translation to Fibre Channel or other format from the native IO format, as required in the conventional system 100, is eliminated. PCIe is, at present, one of the fastest and highest bandwidth standards-based native IO interface. In an embodiment, PCIe interface 212 enables the use of The NVM Express (NVMe) standard, formerly known as the Non-Volatile Memory Host Controller Interface Specification. The NVM Express (NVMe) standard facilitates the adoption and interoperability of PCIe-attached NVM (e.g., PCIe SSD) by providing, among other things, a common interface through which hosts can access NVM devices having different specifications and/or manufacturers. The NVMe interface provides an optimized command issue and completion path. It includes support for parallel operation by supporting multiple command queues within an IO queue, and includes features supporting capabilities such as end-to-end data protection, error reporting, and virtualization.

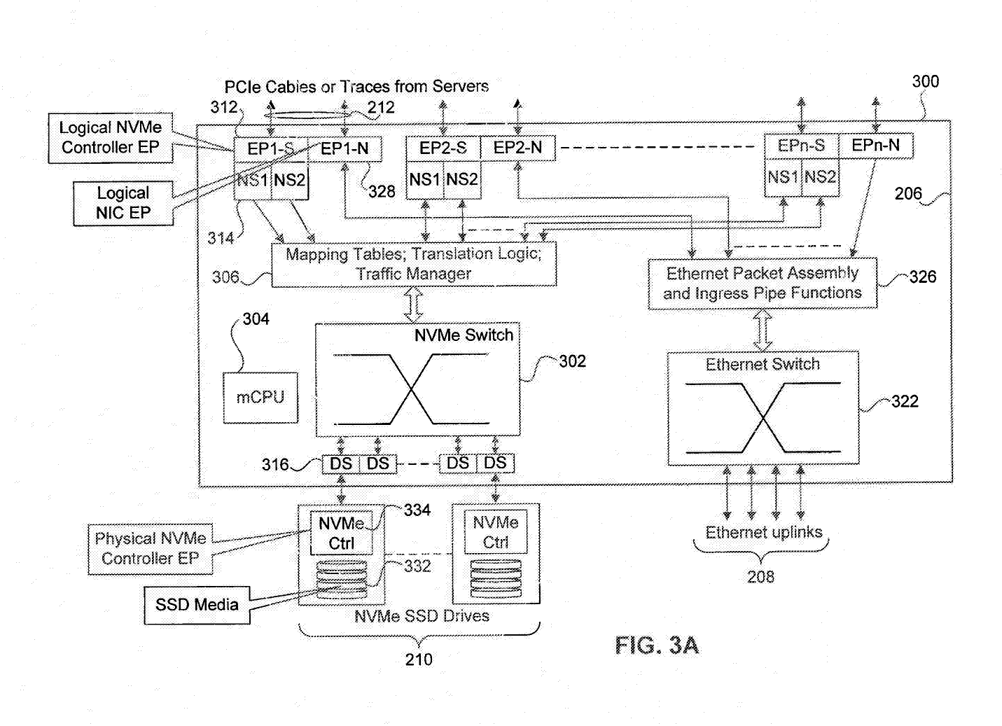

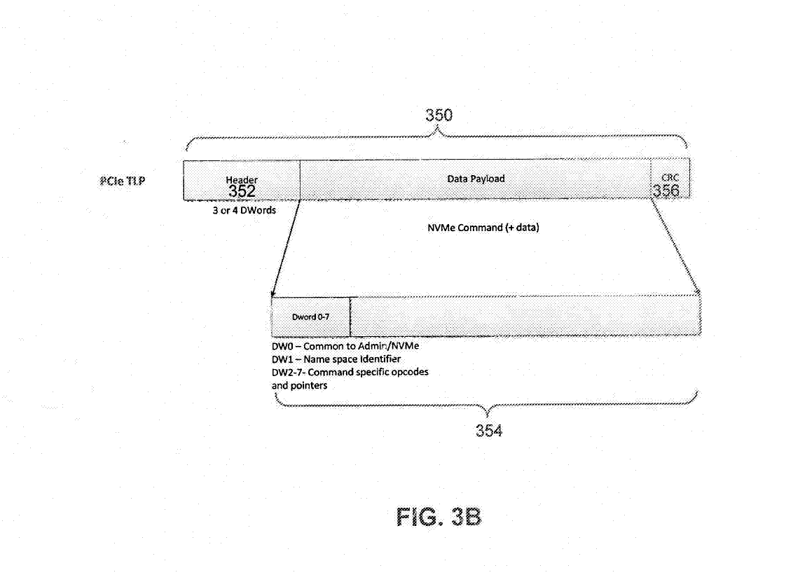

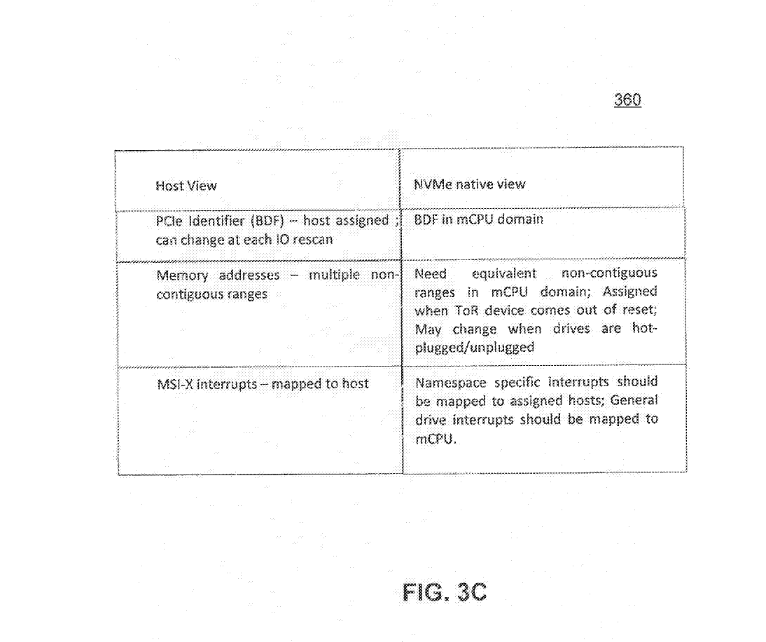

Multiservice IO switch 206 enables servers to be decoupled from their input/output devices, such as persistent storage drives 210. Multiservice IO switch 206, in some embodiments, includes a storage transaction switch 220 and a network switch 230. In some other embodiments, multiservice IO switch 206 may not include network switch 230. The multiservice IO switch 206 provides the servers 102 with switched access to the pool of persistent storage drives 210. In addition, when equipped with network switch 230, the multiservice IO switch 206 provides each server 102 with access to external networks (via network uplinks 208) and network access to other servers 102. In the embodiment illustrated in FIG. 2, the network is based upon Ethernet. A person of skill in the art would appreciate, however, that other network technologies too may be used in addition to, or in place of, the Ethernet network. Multiservice IO switch 206 is discussed further in relation to FIGS. 3A-3C below.

FIG. 3A illustrates a multiservice IO switch 300, in accordance with an embodiment. In at least some embodiments, multiservice IO switch 300 may be similar in operation to multiservice IO switch 206 discussed above.

Multiservice IO switch 300 provides switching and translation of traffic from the PCIe cables or traces 212 from one or more servers to NVMe SSD drives 210, or vice versa. The traffic from the servers to the persistent storage drives may include data read or write requests and control commands. The traffic in the direction from the persistent storage drives to the servers may include data being accessed by the servers and/or status information regarding the accesses.

Multiservice IO switch 300 includes a Storage transaction switch 302, at least one management processor 304, and a switch manager module 306. Within switch 300, traffic may be directed between any of logical storage endpoints EP1-S . . . EPn-S 312 and downstream storage endpoints DS1 . . . DSm 316. Some embodiments may incorporate a network switch 322 in the multiservice IO switch.

Data traffic on the native IO bus from each server terminates at the multiservice IO switch 300 at logical storage endpoints EP1-S . . . EPn-S 312. In the embodiment illustrated, the native IO bus from each server to the multiservice IO switch 300 is a PCIe interface. Each logical storage endpoint EP1-S . . . EPn-S 312 is a PCIe endpoint and is further configured as an NVMe endpoint. From the servers' point of view, each EP1-S . . . EPn-S 312 appears as a PCI endpoint. Further, each EP1-S . . . EPn-S 312 is configured to operate as a virtual NVMe controller.

Each logical storage endpoint EP1-S . . . EPn-S 312 can be configured to be associated with none, one or more namespaces 314. Namespaces are defined in accordance with the NVMe standard, which is incorporated herein by reference. A namespace enables the physical storage space in the pool of persistent storage drives 210 to be partitioned into multiple logical storage spaces, each of which can be accessed independently of other logical storage spaces. In the embodiment illustrated in FIG. 3A, two namespaces (e.g., NS1 and NS2) are available to access the shared persistent storage drives 210. Additional namespaces can be created as will be understood by those skilled in the art.

Each persistent storage drive 210, includes a storage media (e.g., SSD media) 332 and a storage controller 334 that enables external hosts read and write access to the storage media 332. In the embodiment illustrated in FIG. 3, each storage controller 334 is configured as an NVMe controller that operates according to the NVMe standard. The NVMe controller in each NVMe storage device is referred to as a physical NVMe controller. Further, each storage controller 334 is communicatively coupled to a PCIe downstream port 316 in multiservice IO switch 300.

When multiservice IO switch 300 is configured, the logical storage endpoints 312 expose and advertise independent persistent storage drives to each server connected to the logical storage endpoints 312. The physical storage spaces that correspond to the independent persistent storage drives exposed to servers exist in the persistent storage drives 210 coupled via downstream ports DS1 . . . DSm 316.

Storage transaction switch 302 switches the incoming PCIe transaction layer packets (TLP) between logical storage endpoints 312 and downstream ports 316. In some embodiments, storage transaction switch 302 switches NVMe commands that are transported as embedded messages in PCIe TLPs. The NVMe protocol relies upon a set of queues and commands defined for the host (e.g., server) and the target device (e.g., storage media). According to an embodiment, the NVMe protocol messages are carried in PCIe messages. Thus, PCIe is used as a transport layer to carry NVMe messages between servers 202 and persistent storage drives 210.

FIG. 3B illustrates the format of an example PCIe TLP 350. PCIe TLP 350 includes a PCIe header 352, NVMe message 354, and a cyclic redundancy check (CRC) 356. The PCIe header 352 may have a variable length and each TLP may indicate the length of the PCIe header. This enables detection of the start of the NVMe message (e.g., the data payload of the PCIe TLP) in the PCIe TLP. The PCIe header 352 includes a target PCIe identifier (ID) or memory address. The CRC 356 includes a parity check to enable the receiver to verify the integrity of the TLP. The NVMe message 354 may be either an Admin command or an NVMe command. Admin commands are used to set up queues and manage controllers, such as NVMe controller 334. NVMe commands are used to access storage. Both of these commands have the same format in the first 8 double words as shown. Both of these command types have a namespace identifier field in the NVMe message header.

Storage transaction switch 302 switches PCIe TLP based upon the namespace identifier in the NVMe message carried in the PCIe TLP. In some embodiments, the PCIe header which contains the target PCIe identifier or memory address may not be sufficient for making the switching decision. This is in direct contrast to conventional PCIe switches which perform all switching based upon either the target PCIe identifier or target memory address.

In system 200, the persistent storage drives 210 are distributed under multiple controllers (e.g., each SSD media having its own physical NVMe controller) and thus different servers 202 cannot use conventional PCIe switching to share the aggregated storage media provide by persistent storage drives 210.

According to PCIe operation, a server would discover a PCIe device attached to any of its PCIe interfaces. The discovered PCIe device is owned by a PCIe root complex on the server, and the server communicates with the discovered device using PCIe device identifiers (e.g., bus, device, function) and memory addresses. When there are multiple IO devices under the same root complex, they may be connected by a PCIe switch to the server. Such a switch will route PCIe messages based on ID or memory address. NVMe uses this method to enable multiple persistent storage drives to be accessed by a host.

If multiple hosts are to share a single media, NVMe protocol allows them to be shared across the hosts by defining namespaces to logically slice access to the storage media, and also by providing a method to set and claim reservations to atomically access the shared storage media. However, these methods require that the media be accessible from each of the NVMe controllers. Therefore, in embodiments, multiservice IO switch 206 introduces a layer of translation and switching between the physical NVMe controllers 334 corresponding to respective persistent storage drives 210 and servers 202 by providing virtual NVMe controllers (e.g., associated with storage endpoints 312) that can map to more than one persistent storage drive 210.

The switching of the storage transactions by Storage transaction switch 302 includes translating the storage transaction from its server view format (which is based upon the virtual NVMe endpoint defined in the multiservice IO switch) to the NVMe controller format (based upon the physical NVMe controllers associated with each persistent storage drive). A storage transaction message, which enters through one or the logical storage endpoints 312 is translated and transmitted to a selected persistent storage drive through a downstream port 316.

Switch control logic 306 provides the control logic for multiservice IO switch 300. Switch control logic 306 may include mapping tables to map between server view and NVMe controller view of persistent storage drives, translation logic to translate between the different views, and traffic management operations to ensure that the traffic from the servers are processed through switch 300 as configured.

FIG. 3C illustrates an example of a mapping table. As illustrated, a mapping table 360 contains several types of mappings including, for example, PCIe device identifiers, memory addresses, and interrupts. The mappings specify how each of the above types of information is translated between the host view and a native NVMe controller view. As discussed above and below, the storage transaction originated by a server would be in the host view, whereas the persistent storage drive expects to receive the transaction in the NVMe native view. The distinctions between the two views are illustrated and discussed below.

The NVMe commands that are initiated by the host will enter storage endpoints 314. These commands that reference host memory could be Read (from NVMe drive into Host Memory) or Write (to NVMe drive from Host Memory). The memory addresses embedded in the command are referencing the local host view. When multiple hosts are connected to device 300, these memory addresses may be overlapping. The mapping table 306 will have the knowledge of the originating Host and the combination of Host identifier and memory address will uniquely identify the address references. However, the controller (e.g. 334) does not have this unique knowledge. Thus, the mapping table 306 will translate the memory addresses into non-overlapping addresses for each transaction from Host to controller 334. When the controller 334 eventually executes the command in the transaction and initiates a read or write transaction to the Host memory (i.e. in the opposite direction), the mapping table 306 will retrieve the tuple that matches the specific destination host and revert the address back to the host domain. This is done because the controller 334 has only one handle (address) but the table 306 has two handles (address and host number) and this mechanism is necessary to keep the controller 334 unchanged.

PCIe device identifiers are different in the two views. The host view device identifiers are host assigned (e.g., in the PCIe root complex of the host) and can change at each IO rescan. They correspond to the logical storage endpoints (e.g., 312) on the multiservice IO switch 300. The device identifiers of the storage drives in the native NVMe view, are based upon the management CPU PCIe 304 root complex.

Memory addresses in the host view are based upon the initial configurations of the respective physical drives. However, the corresponding memory locations in the native NVMe view may change in the physical storage drives due to reset or hot plugin. Mappings are required for translating memory addresses from the host view to native NVMe view may be configured in the mapping table 306.

Interrupts, used for accessing the storage devices by hosts and for other control reasons, are mapped to the host memory space in the host view. In the native NVMe view, these may be mapped to the management CPU 304. However, namespace-specific interrupts (e.g., specific to a storage transaction received from a server) can be mapped to a specific host based upon the namespace.

In some embodiments, multiservice IO switch 300 may further include a network switch 322 (e.g., Ethernet switch) and logic associated with packet switching (packet switching logic) 326. One or more network endpoints EP1-N . . . EPn-N 328 in the multiservice IO switch are coupled to respective native IO busses of servers (e.g., servers 202). According to an embodiment, network endpoints EP1-N . . . EPn-N 328 are connected to respective servers via PCIe. To a server, the corresponding network endpoint 328 appears as its local network interface (e.g., local Ethernet interface). Therefore, network switch 322 enables the servers connected to the multiservice IO switch 300 to communicate with each other or with external networks. Network uplinks (e.g., Ethernet uplinks) 208 provide connectivity to external networks. Packet switching logic 326, coupled to the Ethernet switch 326, operates to receive ingress and egress packets from the native IO interface of the servers connected to the multiservice IO switch and provide the services required to transmit the packet to another server connected to the multiservice IO switch or to an external destination. Services provided may include, but are not limited to, Ethernet packet assembly, traffic management, forwarding table generation and maintenance, and other operations required for packet forwarding.

By integrating a network switch 322 into the multiservice IO switch 300, some embodiments advantageously share the native IO busses that extend from the servers to the multiservice IO switch to transport storage data as well as network data over the same set of cables, or board traces. Moreover, such integration provides advantages in having centralized storage and networking functions.

As discussed herein, transaction switch 302, and traffic manager 306, and mCPU 304 operate to provide switching and translation of traffic from the PCIe cables or traces 212 from one or more servers to NVMe SSD drives 210, or vice versa. In one embodiment, switch transaction switch 302 can be implemented as logic, circuit(s), or a processor that is distinct from that of mCPU 304. In another embodiment, transaction switch 302 is a software module operating on, or in-conjunction with mCPU 304 as will be understood by those skilled in the art. Further, the traffic manager 306 can be implemented in a similar manner.

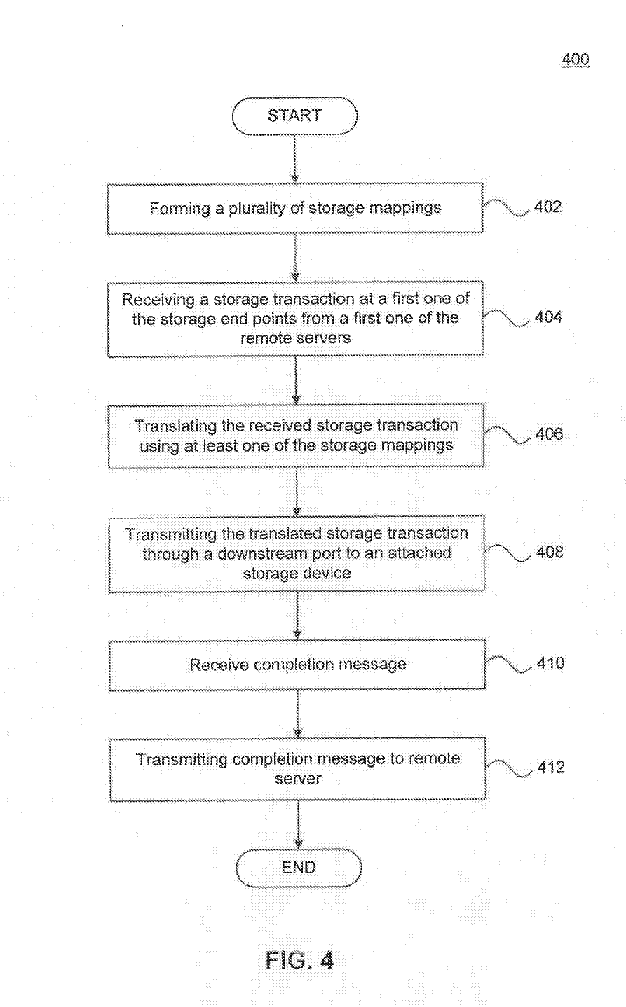

FIG. 4 is a flowchart of a method 400 for sharing storage media among a plurality of servers, in accordance with an embodiment. According to an embodiment, one or more steps 402-412 may not be performed, or may be performed in an order different from that shown. Method 400 may be performed, for example, in configuring and using the multiservice IO switch 206 in system 200 that is further described in FIGS. 3A-3C.

As illustrated in FIG. 2, multiple servers 202 are coupled, using PCIe, to the multiservice IO switch 206. According to the PCIe standard, a separate communication channel exists for each server to communicate with the multiservice IO switch. The PCIe communication channels between the servers and the multiservice IO switch may be in one or more PCIe cables or backplane traces.

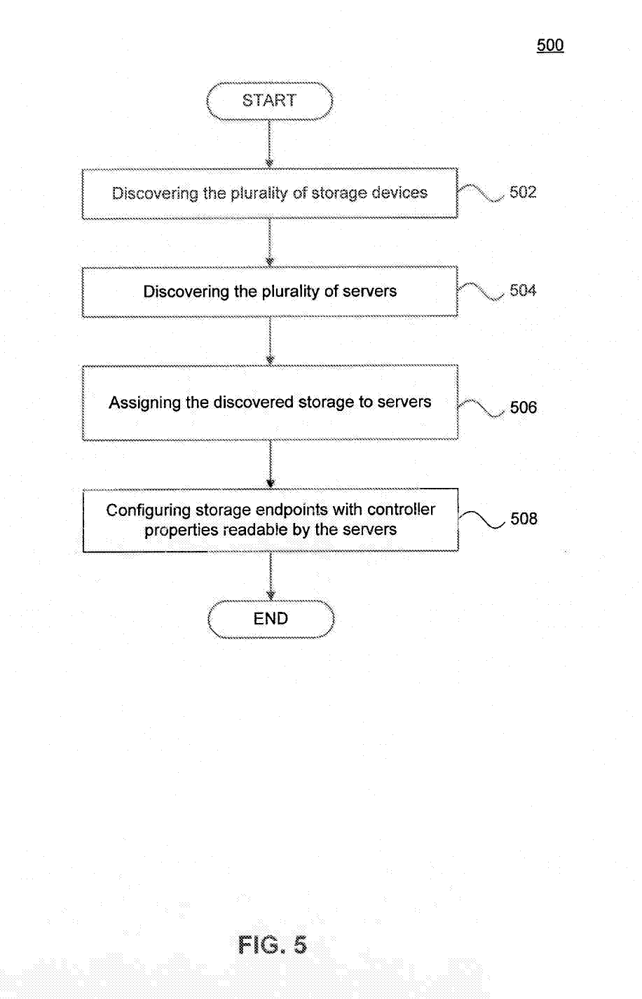

At step 402, the multiservice IO switch (e.g. 206) is configured to provide switching of storage transactions between servers (e.g., servers 202) and a pool of storage media (e.g., storage media 210). A set of logical storage endpoints facing the servers e.g. endpoints 312), and a set of downstream ports (e.g. DS ports 316) representing each of the persistent storage drives (e.g. drives 332) are configured. Each logical storage endpoint is associated with one or more persistent storage drives and is configured to advertise the capabilities of the associated persistent storage drives to the servers. Configuration also includes forming a plurality of mappings specifying how parameters in the storage transactions are to be translated between the servers and the persistent storage drives. In some embodiments, where a network switch is included in the multiservice IO switch, a set of network endpoints (e.g. network endpoints 328) may be configured, manually and/or automatically, for the respective servers to communicate with the network switch. Configuration of the network endpoints may include configuring Ethernet parameters associated with each of the endpoints (e.g., Ethernet address, frame size). Configuration of the multiservice IO switch is further discussed below in relation to FIG. 5.

At step 404, a storage transaction is received at one of the logical storage endpoints from a server. The received storage transaction is addressed to one of the storage endpoints (e.g., EP-S) in the storage transaction switch (e.g. 302). The server would address the storage transaction based upon the properties of the storage endpoint as configured during manual or automatic configuration of the multiservice IO switch, and as discovered by the server during its discovery process.

The server may discover logical storage endpoints and their configurations upon scanning its PCIe device tree either due to a hot-plug mechanism or by reboot. The servers therefore discover the NVMe controller assigned to corresponding logical storage endpoint by configuration at the multiservice IO switch, during configuration of the storage endpoints. Upon discovery, the server populates PCIe configuration registers with the attributes as seen from its point of view. This includes the bus, device, and function (B, D, F) PCIe information of the IO device, memory address ranges in the host server OS, interrupt addresses, etc.

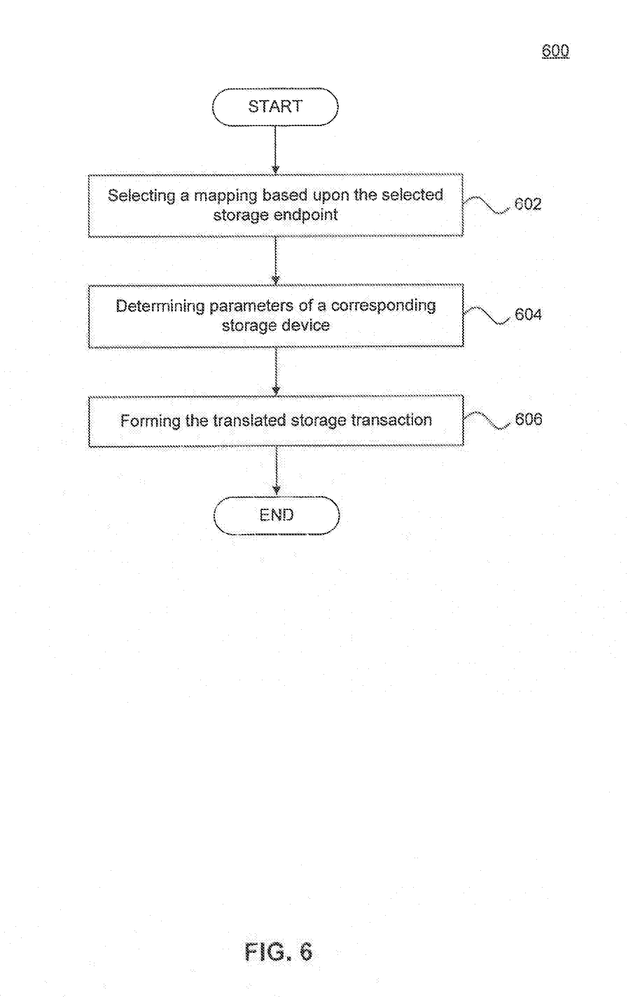

At step 406, the received storage transaction is translated using the mappings configured on the multiservice IO switch. The translation includes mapping the received storage transaction from the host view of the IO device to the native NVMe driver view. The translation process can be performed by traffic manager 306, and is further discussed below in relation to FIG. 6.

At step 408, the translated storage transaction is transmitted to a selected persistent storage drive through a downstream port in the multiservice IO switch. The selected persistent storage drive, which is a NVMe drive (e.g., device including a NVMe controller 334), will be unaware of this transformation because the corresponding NVMe controller will be operating on the assumption that it has been discovered and controlled by the management CPU (e.g. CPU 304) in the multiservice IO switch. After the translation, traffic from servers is transformed to appear as traffic from the management CPU in the multiservice IO switch, and responses from the persistent storage drives will be sent back addressed accordingly to the management CPU (or other entity within the multiservice IO switch, such as a downstream port).

At step 410, a completion message is received. As discussed above, the messages from the persistent storage drives are addressed to the multiservice IO switch. When completions come back from the persistent storage drives, they are forwarded to the appropriate server and this forwarding can be performed by using a “Completion ID” included in the completion message. The Completion ID will be that of the NVMe controller serviced the command, and therefore the assignment of the controller to the server can be found in a mapping that is available in the mapping table (e.g., mapping table 360).

At step 412, the completion message is transmitted to the server. Receipt of the completion message at the server completes the storage transaction according to the PCIe protocol.

FIG. 5 is a flowchart of a method for configuring a multiservice IO switch for storage traffic, in accordance with an embodiment. According to an embodiment, one or more steps 502-512 may not be performed, or may be performed in an order different from that shown. Method 500 may be performed, for example, in configuring the multiservice IO switch 206 in system 200, which further described in FIGS. 3A-3C.

At stage 502, a plurality of persistent storage drives (e.g., storage media 210) are detected. A processor (e.g., mCPU 304) of the multiservice IO switch may initialize a PCIe root complex, as defined in the PCIe protocol, to keep track of reachable PCIe devices. Using the NVMe protocol, NVMe storage devices that are communicatively coupled to the downstream ports (DS) are discovered and identified. Moreover, the capabilities, address spaces, namespace IDs, and other relevant properties of these discovered drives are inventoried. Each of the discovered persistent storage drives are assigned unique namespaces and non-overlapping memory addresses. Each of the NVMe controllers (e.g. 334) will have a unique ID (e.g., in the form of bus, device, function) which enables the mCPU 304 to precisely communicate with each of the discovered storage devices. As discussed above, a namespace enables the physical storage space in the pool of persistent storage drives 210 to be partitioned into multiple logical storage spaces, each of which can be accessed independently of other logical storage spaces. For example, in the embodiment illustrated in FIG. 3A, two namespaces (e.g., NS1 and NS2) are available to access the shared persistent storage drives 210. Additional namespaces can be created as will be understood by those skilled in the art.

At stage 504, remote servers (e.g. servers 202) attached to the multiservice 10 switch are discovered. The logical storage endpoints (e.g., EP-S 312) within the multiservice IO switch that connect to the remote servers are also discovered and inventoried by the mCPU 304. At this stage, these logical storage endpoints represent virtual drives and their capabilities have not yet been advertised to the servers.

At stage 506, the pool of discovered storage is assigned to the discovered servers. Each slice of storage to be allocated is identified by a globally unique namespace identifier. For example, mCPU 304 can control and/or program traffic manager 306 and NVMe switch 302. Additionally, other attributes such as controller identifier, PCIe device identifier, etc., may be used to qualify addressing of specific types of commands. These assignments map respective servers to their storage spaces from the pool of storage.

At stage 508, each PCIe configuration space of EP-S is programmed with the properties of the assigned controller. This is held in the “Controller Registers” section of the PCIe configuration space which is accessible through selected registers (e.g., MLBAR0 and MLBAR1 registers defined in the PCIe specification). These properties are the properties that would be seen by servers during their respective PCIe device discovery processes.

FIG. 6 is a flowchart of a method for performing a storage transaction, in accordance with an embodiment. According to an embodiment, one or more stages 602-606 may not be performed, or may be performed in an order different from that shown. Method 600 may be performed, for example, in translating and switching a received storage transaction in the multiservice IO switch 206 in system 200.

Method 600 begins when a storage transaction received at the multiservice 10 switch from a server is to be switched. At stage 602, appropriate mappings are selected from a mappings table (e.g. traffic manager 306) based upon the storage endpoint at which the storage transaction was received.

At stage 604, based upon the mapping selected in the previous stage, the parameters of a corresponding persistent storage drive are determined. For example, the namespace configurations, corresponding persistent storage drive and identifier information for the corresponding persistent storage drive. Since the incoming storage transaction is addressed to a virtual NVMe controller, the translation of the virtual to physical NVMe controller requires that the addresses from server view of the PCI root tree by mapped into the native NVMe driver view (e.g., PCI root tree view from the management CPU 304 of the multiservice IO switch). This is accomplished by using a mappings table that includes configured translations from the server view to the NVMe driver (e.g. driver 334) view.

At stage 606, the translated storage transaction is formed. The host addresses in the NVMe messages need not be translated because that domain is simply extended and there is no host address domain crossing.

The representative functions of the multiservice IO switch described herein may be implemented in hardware, software, or some combination thereof. For instance, methods 400, 500 and 600 can be implemented using computer processors, computer logic, ASIC, FPGA, DSP, etc., as will be understood by those skilled in the arts based on the discussion given herein. Accordingly, any processor that performs the processing functions described herein is within the scope and spirit of the present disclosure.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments.

What is claimed is:

1. An apparatus comprising:
a plurality of logical storage endpoints, wherein each of the plurality of logical storage endpoints is communicatively coupled to a respective server from a plurality of remote servers via a native input/output bus of the respective server,
a plurality of downstream ports, wherein each of the plurality of downstream ports is communicatively coupled to a respective persistent storage drive from a plurality of persistent storage drives;
a storage transaction switch configured to:
form a plurality of mappings, wherein each mapping of the plurality of mappings corresponds to an assignment of storage space in one or more of the plurality of persistent storage drives to one or more of the remote servers;
receive a storage transaction from a first one of the plurality of logical storage endpoints that is associated with a first one of the remote servers;
translate the received storage transaction using one or more of the plurality of mappings; and
transmit the translated storage transaction through one of the plurality of downstream ports to one of the plurality of persistent storage drives; and
at least one processor configured to communicate with the plurality of remote servers and the plurality of persistent storage drives.

2. The apparatus of claim 1, wherein the storage transaction switch is further configured to:
detect the plurality of persistent storage drives communicatively coupled to the plurality of downstream ports; and
detect the plurality of remote servers communicatively coupled to respective ones of the plurality of logical storage endpoints.

3. The apparatus of claim 2, wherein the storage transaction switch is further configured to discover devices attached to at least one input/output bus.

4. The apparatus of claim 1, wherein the storage transaction switch is further configured to:
configure, for each persistent storage drive of the plurality of persistent storage drives, a corresponding one of the downstream ports to communicate with the persistent storage drive;
assign, for each persistent storage drive of the plurality of persistent storage drives, at least one corresponding unique namespace and at least one corresponding non-overlapping memory address space; and
associate one or more of the plurality of downstream ports with each of the plurality of logical storage endpoints.

5. The apparatus of claim 4, wherein the storage transaction switch is further configured to:
configure each of the plurality of logical storage endpoints with a set of controller properties corresponding to the persistent storage drive associated with the associated downstream port, wherein the configured set of controller properties is detected by one or more of the plurality of remote servers.

6. The apparatus of claim 4, wherein the storage transaction switch is further configured to:
select the one or more mappings based upon the first one of the logical storage endpoints;
determine parameters of a first one of the persistent storage drives, wherein the first one of the persistent storage drives is mapped to the first one of the logical storage endpoints; and
perform the translated storage transaction using one or more of the determined parameters.

7. The apparatus of claim 1, wherein the plurality of persistent storage drives include one or more solid state disks (SSD).

8. The apparatus of claim 1, further comprising:
a plurality of network endpoints, wherein each of the plurality of network endpoints is coupled via a respective input/output bus to one or more of the plurality of remote servers.

9. The apparatus of claim 8, further comprising:
a network switch configured to switch data packets between the plurality of remote servers and destinations reachable via a plurality of network uplinks.

10. A method of sharing a plurality of persistent storage drives between a plurality of remote servers, comprising:
forming a plurality of mappings in a storage transaction switch, wherein each mapping of the plurality of mappings correspond to an assignment of a storage space in one or more of the plurality of persistent storage drives to one or more of the plurality of remote servers;
receiving a storage transaction at a first one of a plurality of logical storage endpoints associated with a first one of the plurality of remote servers;
translating the received storage transaction using one or more mappings of the plurality of storage mappings; and
transmitting the translated storage transaction from one of a plurality of downstream ports to one of the plurality of persistent storage drives.

11. The method of claim 10, wherein the forming a plurality of mappings comprises:
detecting the plurality of persistent storage drives that are communicatively coupled to the plurality of downstream ports; and
detecting the plurality of remote servers that are communicatively coupled to respective ones of the plurality of logical storage endpoints.

12. The method of claim 11, wherein the detecting the plurality of persistent storage drives and the detecting the plurality of remote servers includes discovering devices attached to at least one input/output bus.

13. The method of claim 12, wherein the discovering devices includes discovering devices attached to the at least one input/output bus according to a protocol compliant with a PCIe standard.

14. The method of claim 13, wherein the forming further comprises:
configuring a corresponding one of the downstream ports to communicate with each persistent storage drive of the plurality of persistent storage drives;
assigning at least one corresponding unique namespace and at least one corresponding non-overlapping memory address space to each persistent storage drive of the plurality of persistent storage drives; and
associating one or more of the downstream ports with each of the plurality of logical storage endpoints.

15. The method of claim 14, wherein the forming further comprises:
configuring each of the plurality of logical storage endpoints with a set of controller properties corresponding to the persistent storage drive associated with the associated downstream port, wherein the configured set of controller properties is detected by one or more of the plurality of remote servers.

16. The method of claim 10, wherein the translating comprises:
selecting the one or more mappings based upon the first one of the plurality of logical storage endpoints;
determining parameters of a first one of the plurality of persistent storage drives, wherein the first one of the plurality of persistent storage drives is mapped to the first one of the plurality of logical storage endpoints; and
forming the translated storage transaction using one or more of the determined parameters.

17. The method of claim 16, wherein the translating further comprises:
transmitting the translated storage transaction from one of a plurality of downstream ports to one of the plurality of persistent storage drives.

18. A non-transitory computer readable storage medium storing instructions, that when executed by a processor, causes the processor to perform a method of sharing a plurality of persistent storage drives between a plurality of remote servers using operations comprising:
configuring, for each persistent storage drive of the plurality of persistent storage drives, a corresponding one of a plurality of downstream ports in a storage transaction switch;
assigning at least one corresponding unique namespace and at least one corresponding non-overlapping memory address space to each persistent storage drive of the plurality of persistent storage drives; and
associating one or more of the downstream ports with each of the plurality of logical storage endpoints.

19. The non-transitory computer readable storage medium of claim 18, the operations further comprising:
receiving a storage transaction at a first one of a plurality of logical storage endpoints associated with a first one of the plurality of remote servers;
selecting at least one mapping based upon the first one of the plurality of logical storage endpoints;
determining parameters of a first one of the plurality of persistent storage drives, wherein the first one of the plurality of persistent storage drives is mapped to the first one of the plurality of logical storage endpoints; and
forming a translated storage transaction using one or more of the determined parameters.

20. The non-transitory computer readable storage medium of claim 18, the operations further comprising:
configuring each of the plurality of logical storage endpoints with a set of controller properties corresponding to the persistent storage drive associated with the associated downstream port, wherein the configured set of controller properties is detected by one or more of the plurality of remote servers.
